(19) United States
(12) Patent Application Publication
(10) Pub. No.: US 2007/0149685 A1
(43) Pub. Date: Jun. 28, 2007

(54) High tenacity nanocomposite and method for producing the same

(75) Inventors: Wen-Faa Kuo, Hsinchu (TW); Shih-Jung Tsai, Hsinchu (TW); Gwo-Yang Chang, Taipei (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/440,104

(22) Filed: May 25, 2006

(30) Foreign Application Priority Data
Dec. 27, 2005 (TW) 94146614

(51) Int. Cl. C08K 9/04

(52) U.S. Cl. 524/445

(57) ABSTRACT

The present invention relates to a nanocomposite material, which comprises bedded clay modified by alkyl amino salt with long chain and a silicone compound with functional group, then mix with a polymer compound. The present invention has a high rigidity and tenacity by inserting the polymer compound into the layers of the modified clay.

### BACKGROUND OF THE INVENTION

1. Field of the Invention

The present invention relates to an organic modified bedded clay and a preparing method for using the same, more particularly, to a nanocomposite material prepared by the mentioned organic modified bedded clay.

2. Description of Related Art

The nanocomposite material is provided with a dispersed phase of inorganic composition, the diameter of the particle is between 1˜100 nano meter (10⁻⁹ m) and is capable of elaborating the nano effect of the complex material. According to the current technology, nanocomposite material is able to provide a better mechanical strength, rigidity, heat resistance, lower water absorption, flammability and air permeability than the conventional composite material. In the commercial produced nanocomposite materials, for example, the nylon-6/clay nano material shows that the bedded clay is dispersed in the polymer matrix then is able to improve the mechanical strength, heat distortion temperature and water-absorption/resistance.

The present manufacturing process of nanocomposite material is to fuse and mix the polymer matrix, the coupling agent and the organic clay by the twin-screw extruder. The organic clay is inserted and dispersed by the coupling agent and the polymer matrix in process. This kind of bedded clay composite material is capable of practicing the structure property of molecule degree, which comprises, high strength, high rigidity, high heat resistance, low water absorption, low air permeability and multi-recyclable. However, it is able to improve the tensile strength, the bend strength and the bend elastic modulus, but the impact resistance is still not increased. Therefore, it will be provided with high application value in developing the high tenacity nanocomposite clay material and not decrease the rigidity in the meantime.

### SUMMARY OF THE INVENTION

Due to the shortcoming of the prior art, the object of the present invention is to provide a polymer-nano clay composite material, which means the material not only has to provide with high rigidity, but further to increase the tenacity in order to make the material is able to resist impact.

Further, the present invention increases the surface compatibility of polymer and clay by the way of modifying clay; further it is able to make surface more homogeneous when insert the polymer between the bedded clay. It improves the property of nanocomposite materials.

To achieve the objects above, the organic modified bedded clay of the present invention comprising: a bedded clay; an alkyl amino salt compound with long carbon chain; and a silicone compound with functional groups, which is located between layers of the bedded clay. The organic modified bedded clay of present invention improves the tenacity of applying with nanocomposite materials by the tenacity effect of silicon compound.

In some embodiments, the organic modified bedded clay further comprises a coupling agent. The coupling agent is a silane compound with functional groups. Applying with the functional group of the coupling agent is able to develop the compatibility of the nanocomposite material and the polymer matrix in organic modified clay application.

For preparing the mentioned organic modified bedded clay, the present invention provides a method of preparing the organic modified clay comprising the following steps: (a) providing a bedded clay; (b) dispersing the bedded clay in a solution; (c) adding an alkyl amino salt compound with long carbon chain into the solution of step (b) for reaction; (d) adding the silicone compound with functional groups for reaction and then to form a precipitate; and (e) drying the precipitate of step (d).

The present invention applies with the ion exchange reaction in order to make the alkyl amino salt compound with long carbon chain inserted between the layers of the clay for enlarging the distance between each layer of the clay by using the solid effect of long carbon chain, and the silicone compound is used for filling between the clay layers for improving the tenacity of clay applied in the nanocomposite material.

In some embodiments, the step (d) of the preparing method of the organic modified bedded clay of the present invention not only comprises adding a silicone compound with functional groups but further comprises a coupling agent, for example, but not limited to a silane with functional groups. The coupling agent can make the obtained surface of the organic modified bedded clay comprises functional groups, and it is helpful for improving the interface compatibility of the bedded clay and polymer matrix.

The organic modified bedded clay of the present invention is able to fuse and mix with polymer matrix for forming a nanocomposite material of nano degree.

Therefore, the present invention further provides a nanocomposite material comprising: a bedded clay; an alkyl amino salt compound with a long carbon chain; and a silicone compound with functional group, which is located between layers of the bedded clay; and at least one polymer matrix, which is mixed between said bedded clay.

In some embodiments, the nanocomposite material of the present invention further comprises a coupling agent, which has a silane compound with functional groups, which makes the clay and polymer matrix are provided with better interface reactivity.

The organic modified bedded clay of the present invention is provided with silicone compound, which is able to improve the tenacity. Further, to add a coupling agent for improving the interface reactivity and making the clay and the polymer matrix are provided with a better interface compatibility. The nanocomposite material formed by fusing and mixing the clay and the polymer matrix is provided with fine tenacity and fine rigidity.

Other objects, advantages, and novel features of the invention will become more apparent from the following detailed description when taken in conjunction with the accompanying drawings.

### BRIEF DESCRIPTION OF THE DRAWINGS

FIG. 1 is the structure of the organic modified bedded clay of the present invention.

FIG. 2 is the preparing process of organic modified bedded clay of the present invention.

FIG. 3 is the comparison figure of the surface electronic microscope of the nanocomposite material impact section of the present invention, wherein that the left upper side is PP-7633, right upper side is NPP-46 sample, the left lower side is NPP-51 sample and the right lower side is NPP-41 sample.

FIG. 4 is the comparison figure of the surface electronic microscope of the nanocomposite material impact section of the present invention, wherein that the left upper side is PP-6331, right upper side is NPP-61 sample, the left lower side is NPP-66 sample and the right lower side is NPP-57 sample.

### DETAILED DESCRIPTION OF THE PREFERRED EMBODIMENT

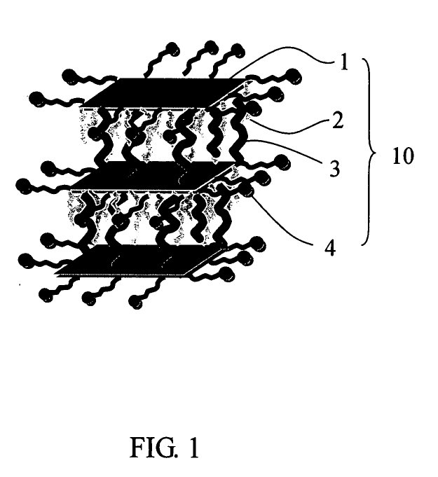

FIG. 1 is the structure figure of organic modified bedded clay 10 of present invention, which is composed with the bedded clay 1, the alkyl amine salt compound with long carbon chain 2 and the silicone compound with functional groups 3, which is located between the bedded clay 1. The composed ratio is varied by the material property of bedded clay 1, in general examples of the present invention, the organic modified bedded clay 10 of present invention is composed by 10 wt %˜80 wt % bedded clay 1; 10 wt %˜80 wt % alkyl amino salt compound with long carbon chain 2; and 10 wt %˜80 wt % silicone compound with functional groups 3.

The organic modified bedded clay 10 of present invention increases the distance between bedded clay layers by inserting the alkyl amino salt compound with long carbon chain 2 into each layer of bedded clay 1. The processing of inserting reaction is to disperse bedded clay 1 into a solution and make the alkyl amino salt compound with long carbon chain 2 contacts with the clay in the solution for processing the ion exchange reaction, it is better to process the reaction in the relative acid condition. In the meantime, the amino salt functional group forms a amino group with quaternary positive charge, which is able to mix with a clay provided with an ion exchange equivalent of 50˜200 meg/100 g, for example, MMT, mica, talcum powder or mixture thereof for process an ion exchange reaction.

The alkyl amino salt compound 2 with long carbon chain of present invention is provided with 8˜20 carbons, after inserting to bedded clay 1, the distance between the bedded clay layers is able to enlarge by applying the long carbon chain solid structure. The alkyl amino salt compound with long carbon chain 2 includes, but not limited to octadecyl amino or alkylbenzyl ammonium salt, which is provided with formula (I).

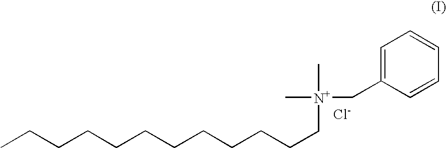

The organic modified bedded clay 10 of present invention not only increase the distance between bedded clay layers by alkyl amino salt compound with long carbon chain 2, but to modify by silicone compound with functional groups 3. The purpose above is to increase the tenacity of clay by applying with the tenacious effect of silicone compound 3, the silicone compound with functional groups 3 comprises siloxanes, which has silicone structures, for example, a silicone oil which has amino group at the end or branch chain.

The organic modified bedded clay 10 of present invention is not only modified by silicone compound 3, but further added a coupling agent in order to achieve the effect of surface modification. With reference of FIG. 1, the coupling agent 4 is able to make each layer of clay 1 provided with reactivity and then to apply with the interface compatibility of polymer matrix when prepare the nanocomposite material. The adding volume of coupling agent 4 is about 0.1 wt % 20 wt % of organic bedded modified clay, which comprises silane compound containing amino, acryl glycidyl, acrylic acid or methacrylic acid function group. The silane compound comprises but not limit to γ-amino propyl trimethoxy silane, γ-acryl glycidyl propyl trimethoxy silane or γ-methacrylic propyl trimethoxy silane.

The distance between layers of organic bedded modified clay of present invention is able to enlarge from 12 Å to 25˜30 Å analyzed by X-ray. The enlarged layer distance can make the clay of present invention is benefit in making the polymer dispersed into the clay layers.

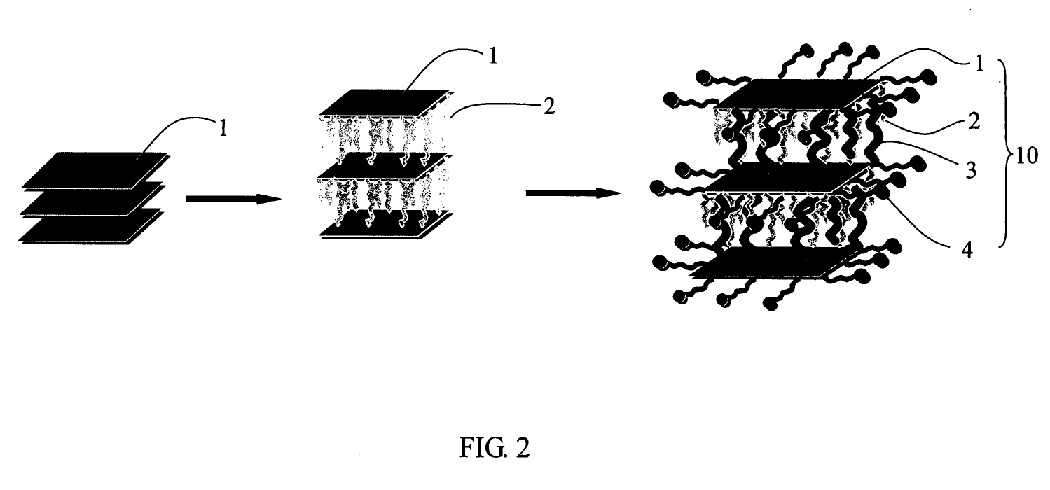

In order to obtain the organic bedded modified clay of present invention, the present invention provides a preparing method of organic bedded modified clay, as shown in FIG. 2, the steps are as follow: first, to provide bedded clay 1, the material of the clay is as definition above, disperse bedded clay 1 into a solution, the solution has to be inertia when reacts with the reactants of each step and easy to be dry removed after the reaction. The aqueous solution is used in the embodiment of the present invention because the water is easy to obtain and it is a suitable solvent.

Before adding the alkyl amino salt compound with long carbon chain 2 into the solution comprised with clay, the solution can be further adjusted to a relative acid condition for favoring in the amino salt functional group is capable of forming an amino group with quaternary positive charge when add the alkyl amino salt compound with long carbon chain 2 into the solution. Additionally, the temperature of the solution is able to adjust to the heating condition of under the solvent boiling point to favor in the process of the reaction afterward. For example, adjust the temperature to about 75° C. and keep it, it is benefit in the process of the reaction.

Add alkyl amino salt compound with long carbon chain 2 into the solution comprised with clay for reaction. Make the alkyl amino slat compound with long carbon chain 2 inserts into each layer of clay 1 by processing the ion exchange reaction and further to enlarge the distance between the clay layers. The alkyl amino salt compound with long carbon chain 2 in provided with 8˜20 carbons, which is included but not limited to octadecyl amine or the alkylbenzyl ammonium salt, which is provided with formula (I).

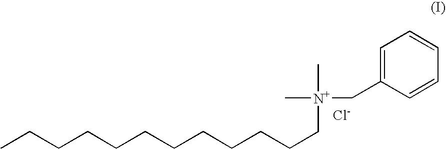

Then, add the silicone compound with functional groups 3 into the solution for the modification of bedded clay. After the modification, the material of making the nanocomposite material and the silicone compound with functional groups, which comprises the high tenacity, is as definition above.

Obtain a precipitate from the above reaction, washing the precipitate with the reaction solvent (for example, water) before drying it, then dry the crude product again to obtain the organic modified bedded clay of present invention.

In the method of preparing organic modified bedded clay, after or add the silicone compound with functional groups at the same time can further add a coupling agent for processing the modification of clay surface. Preferably, the coupling agent is silane compound with functional groups. The selection of the coupling agent is applied as mentioned above, which it provides the interface compatibility of polymer matrix when prepare the nanocomposite matrix.

The organic modified bedded clay of the present invention fuse and mix with polymer matrix in order to form the nanocomposite material which is provided with high rigidity and high tenacity. Therefore, the nanocomposite material of the present invention comprises a bedded clay, an alkyl amino salt compound with long carbon chain, a silicone compound with functional groups, and at least one polymer matrix, wherein the bedded clay, alkyl amino salt compound with long carbon chain and silicone compound with functional groups is defined as mentioned above. The material of polymer matrix is well known in the field of nanocomposite material, includes but not limit to polyolefin, polyamide or polyester. Moreover, when the composition of organic modified bedded clay comprises a coupling agent, the nanocomposite material comprises the coupling agent.

The “fuse and mix” means the technique of mix the organic modified bedded clay and polymer matrix homogeneously via the extruder and other mixing machines. In some embodiments, in order to increase the tenacity of the polymer matrix and also increase the homogeneous degree of mixing the bedded clay, it can be achieved by adding the processing oil in the mixture then fuse and mix by the extruder. The various kinds of processing oil comprise white mineral oil, rubber-soften oil or silicone monomer solution (one embodiment of silicone oil). The adding volume is about 2 wt %.

In the preferred embodiment, the nanocomposite material of the present invention comprises 1 wt %˜12 wt % the bedded clay; 1 wt %˜10 wt % the alkyl amino salt compound with long carbon chain; 1 wt %˜12 wt % the silicone compound with functional groups; and 80 wt %˜90 wt % the polymer matrix, and can further comprise 0.1 wt %˜20 wt % the coupling agent. However, each composition varies according to the properties of the organic modified clay and the nanocomposite material.

The present invention is further depicted in the illustration of examples, but the descriptions made in the examples should not be construed as a limitation on the actual application of the present invention.

### EXAMPLE 1

### Prepare Organic Modified Bedded Clay and Nano Complex Material of the Present Invention

Organic Modified Bedded Clay

First, disperse the clay in the water then adjust the pH value lower than 7, make the temperature at about 75° C. for starting the modification of clay. Add dimethyldodecylbenzyl ammonium chloride salt or octadecyl amine and stir continuously in order to make the alkyl amino salt with long carbon chain process ion exchange with the clay and insert into the clay. And then add silicone oil of silicone polymer structure, then in the meantime or afterward, optionally add the coupling agents, stir the solution then dry the precipitate, it is able to cooperate with some steps such as, wash for removing the impure objects in the product, and then the organic modified bedded clay of present invention is obtained.

High tenacity nanocomposite material forms nano organic modified bedded clay which is provided with silicone compound after processing surface modification with the alkyl amino salt compound with long carbon chain and the silicone compound, and then mix with the polymer matrix. The polymer-clay nanocomposite material of present invention is obtained by melting and mixing in the extruder.

Compare 1: Comparison of the Nanocomposite Material of Present Invention and Prior Arts

The preparing method of nanocomposite material of present invention can be referred to example 1. The comparison of prior art is the commercialized product of polypropylene-clay composite material of PolyOne, which is first to prepare organic clay as the concentrated particles of 38˜42 wt % (MB 1001), then add into the polypropylene matrix, the adding volume is about 10˜20 wt %.

Table 1 is the comparison of the nanocomposite material of present invention and prior arts:

TABLE 1

| | Prior art | | | | | | |
|---|---|---|---|---|---|---|---|
| | (PolyOne) | | | Present invention | | | |
| Clay treatment | clay/organic amino salt | | | clay/alkyl amino salt with long carbon | | | |
| | compound | | | chain/silicone compound/coupling agent | | | |
| Distance between the | ˜ | | | d001 is inserted from 12 Å to 25˜30 Å | | | |
| layers of clay | | | | | | | |
| polymer/clay | Nanoblend compound/Organoclay | | | Fuse and mix process of modified | | | |
| nanocomposite | concentrates (˜40%) and | | | Organoclay and PP matrix | | | |
| preparing method | PP matrix fuse and mix process | | | | | | |
| | Sample composition | | | | | | |
| | | | | 5% clay | | 5% clay | |
| | | | | (clay/TL*/ | 5% clay | (clay/oda*/ | 5% clay |
| | 0% conc. | 20% conc. | 0% clay | silicone/silane) | (clay/TL) | silicone) | (clay/oda) |
| | MB1001 | MB1001 | PP-7633 | NPP-46 | NPP-41 | NPP-07 | NPP-10 |
| Tensile strength | 377 | 417 | 126 | 210 | 215 | ˜ | ˜ |
| (kg/cm²) | | | | | | | |
| Elongation (%) | 25 | 15 | 139 | 505 | 474 | ˜ | ˜ |
| Bend strength | 550 | 682 | 462 | 413 | 416 | ˜ | ˜ |
| (kg/cm²) | | | | | | | |
| Bend elastic modulus | 16507 | 24945 | 13317 | 14530 | 14230 | 14083 | 16262 |
| (kg/cm²) | | | | | | | |
| Notched Izod Impact | 2.18 | 2.18 | 20.68 | 80.72 | 26.08 | 89.23 | 31.73 |
| (kg-cm/cm) | | | | | | | |

*TL is dimethyldodecyl benzyl ammonium salt. Oda is octadecyl amine salt.

As shown in Table 1, the Notched Izod Impact of prior art is about 2 kg-cm/cm, and the Notched Izod Impact of present invention is able to rise over 80 kg-cm/cm, it is effective in increasing the tenacity of nanocomposite material.

### EXAMPLE 2

### Notched Izod Impact of Nanocomposite Material

Table 2 is the comparison of Notched Izod Impact of polypropylene-clay nanocomposite material, wherein TL-17 means the clay of present invention modified by alkyl amino salt with long carbon chain/silicone compound/coupling agent, TL-15 is the clay modified only by alkyl amino salt with long carbon chain. One embodiment of processing oil is silicone oil. According to the Table 2, for PP-76233, adding little silicone oil is benefit in improving the notched izod impact nanocomposite material. Adding silicone compound modified nano organic modified bedded clay (TL-17), the notched izod impact property of polypropylene/clay nanocomposite material improves the tenacity by increasing the clay volume. But for TL-15, which is not comprised with silicone compound, the notched izod impact is first rising by the increasing of clay amount then dropping off when the clay amount is increased again. It is obvious that the impact resist reduce significantly when compare with the organic modified clay comprised with silicone compound. On the other hand, when using PP-6331 as the formula of polymer matrix, the variation is similar to PP-7633, wherein that the improvement of notched izod impact in applying PP-7633 is over 250˜300%, and applying PP-6331 is over 50˜100%.

TABLE 2

| | Sample | | | | | | | |
|---|---|---|---|---|---|---|---|---|
| | PP-7633 | NPP-36 | NPP-37 | NPP-39 | NPP-40 | NPP-41 | NPP-42 | NPP-43 |
| PP -7633 (MI = 1.8) | 100 | 100 | 100 | 100 | 100 | 100 | 100 | 100 |
| TL-17 | 0 | 0 | 0 | 0 | 0 | 0 | 0 | 0 |
| TL-15 | 0 | 0 | 0 | 1 | 3 | 5 | 7 | 10 |
| Processing oil | 0 | 1 | 2 | 1 | 1 | 1 | 1 | 1 |
| Impact(kg-cm/cm) | 20.68 | 60.34 | 79.21 | 72.97 | 38.28 | 26.08 | 21.48 | 20.1 |

| | Sample | | | | | | | |
|---|---|---|---|---|---|---|---|---|
| | NPP-44 | NPP-45 | NPP-46 | NPP-47 | NPP-48 | NPP-49 | NPP-50 | NPP-51 |
| PP -7633 (MI = 1.8) | 100 | 100 | 100 | 100 | 100 | 100 | 100 | 100 |
| TL-17 | 1 | 3 | 5 | 7 | 10 | 1 | 3 | 5 |
| TL-15 | 0 | 0 | 0 | 0 | 0 | 0 | 0 | 0 |
| Processing oil | 0 | 0 | 0 | 0 | 0 | 1 | 1 | 1 |
| Impact(kg-cm/cm) | 69.36 | 75.31 | 80.72 | 86.08 | 91.75 | 84.21 | 85.26 | 86.25 |

| | Sample | | | | | | |
|---|---|---|---|---|---|---|---|
| | PP-6331 | NPP-52 | NPP-53 | NPP-55 | NPP-56 | NPP-57 | NPP-58 |
| PP -6331 (MI = 14) | 100 | 100 | 100 | 100 | 100 | 100 | 100 |
| TL-17 | 0 | 0 | 0 | 0 | 0 | 0 | 0 |
| TL-15 | 0 | 0 | 0 | 1 | 3 | 5 | 7 |
| Processing oil | 0 | 1 | 3 | 1 | 1 | 1 | 1 |
| Impact(kg-cm/cm) | 3.09 | 4.41 | 4.75 | 3.87 | 4.21 | 4.09 | 3.6 |

| | Sample | | | | | | | | |
|---|---|---|---|---|---|---|---|---|---|
| | NPP-59 | NPP-60 | NPP-61 | NPP-62 | NPP-63 | NPP-64 | NPP-65 | NPP-66 | NPP-67 |
| PP -6331 (MI = 14) | 100 | 100 | 100 | 100 | 100 | 100 | 100 | 100 | 100 |
| TL-17 | 1 | 3 | 5 | 7 | 10 | 1 | 3 | 5 | 7 |
| TL-15 | 0 | 0 | 0 | 0 | 0 | 0 | 0 | 0 | 0 |
| Processing oil | 0 | 0 | 0 | 0 | 0 | 1 | 1 | 1 | 1 |
| Impact(kg-cm/cm) | 4.58 | 5.38 | 6 | 6.25 | 5.56 | 4.75 | 6.25 | 5.81 | 5.71 |

### EXAMPLE 3

### The Mechanical Property of Nanocomposite Material

Table 3 is the comparison of the mechanical property of polypropylene-clay nanocomposite material, as shown in Table 3, for PP-7633, add silicone compound modified TL-17 into polypropylene copolymer matrix then extrude by extruder in fuse and mix method for preparing the high tenacity PP-clay nanocomposite material. The mechanical property (tensile strength, elongation, bend strength and bend elastic coefficient are improved by increasing the clay amount, and the notched izod impact (adding volume 5 wt %) is about 80˜86 kg-cm/cm (rising over 300%), it is obvious improvement and bend elastic coefficient increases a little for achieving the high tenacity and rigidity of polypropylene-clay nanocomposite material. If the organic modified clay doesn't comprise silicone compound (TL-15), the notched izod impact is about 26 kg-cm/cm (increase 25%), it is obvious comprised a lower impact value than silicone comprised organic modified clay. Besides, as to PP-6331, the variation is similar to PP-7633, but the improvement of notched izod impact is relatively smaller.

TABLE 3

| | Sample | | | | | | | |
|---|---|---|---|---|---|---|---|---|
| | NPP-36 | NPP-40 | NPP-41 | NPP-45 | NPP-46 | NPP-50 | NPP-51 | PP7633 |
| PP -7633 (MI = 1.8) | 100 | 100 | 100 | 100 | 100 | 100 | 100 | |
| PP -6331 (MI = 14) | | 0 | 0 | 0 | 0 | 0 | 0 | |
| TL-17 | | 0 | 0 | 3 | 5 | 3 | 5 | |
| TL-15 | | 3 | 5 | 0 | 0 | 0 | 0 | |
| Processing oil | 1 | 1 | 1 | 0 | 0 | 1 | 1 | |
| Impact(kg-cm/cm) | 60.34 | 38.28 | 26.08 | 75.31 | 80.72 | 85.26 | 86.25 | 20.68 |
| Elongation (%) | 364 | 435 | 474 | 489 | 505 | 502 | 492 | 139 |
| Tensile strength | 175 | 201 | 215 | 211 | 210 | 216 | 196 | 126 |
| (kg/cm²) | | | | | | | | |
| Bend strength | 396 | 428 | 416 | 422 | 413 | 410 | 407 | 462 |
| (kg/cm²) | | | | | | | | |
| Bend elastic modulus | 12140 | 14120 | 14230 | 14370 | 14530 | 14670 | 14340 | 13317 |
| (kg/cm²) | | | | | | | | |

| | Sample | | | | | | | |
|---|---|---|---|---|---|---|---|---|
| | NPP-52 | NPP-56 | NPP-57 | NPP-60 | NPP-61 | NPP-65 | NPP-66 | PP-6331 |
| PP -7633 (MI = 1.8) | | | | | | | | |
| PP -6331 (MI = 14) | 100 | 100 | 100 | 100 | 100 | 100 | 100 | |
| TL-17 | | 0 | 0 | 3 | 5 | 3 | 5 | |
| TL-15 | | 3 | 5 | 0 | 0 | 0 | 0 | |
| Processing oil | 1 | 1 | 1 | 0 | 0 | 1 | 1 | |
| Impact(kg-cm/cm) | 4.41 | 4.21 | 4.09 | 5.38 | 6 | 6.25 | 5.81 | 3.09 |
| Elongation (%) | 52 | 52 | 37 | 33 | 49 | 41 | 39 | 28 |
| Tensile strength | 189 | 220 | 252 | 231 | 228 | 226 | 224 | 243 |
| (kg/cm²) | | | | | | | | |
| Bend strength | 568 | 609 | 600 | 627 | 607 | 582 | 578 | 593 |
| (kg/cm²) | | | | | | | | |
| Bend elastic modulus | 17224 | 21010 | 21520 | 22620 | 22290 | 21190 | 20860 | 16900 |
| (kg/cm²) | | | | | | | | |

### EXAMPLE 4

### Comparison of Surface Electronic Microscope Figures of Nanocomposite Material Impact Section

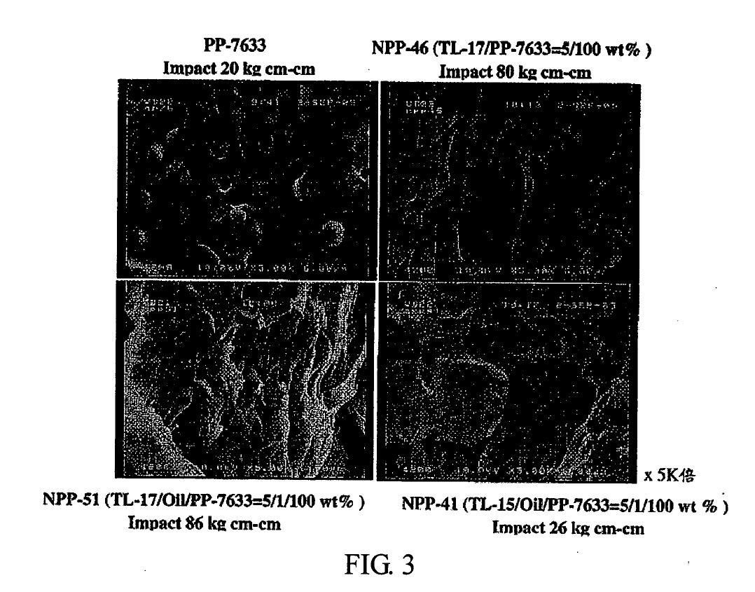

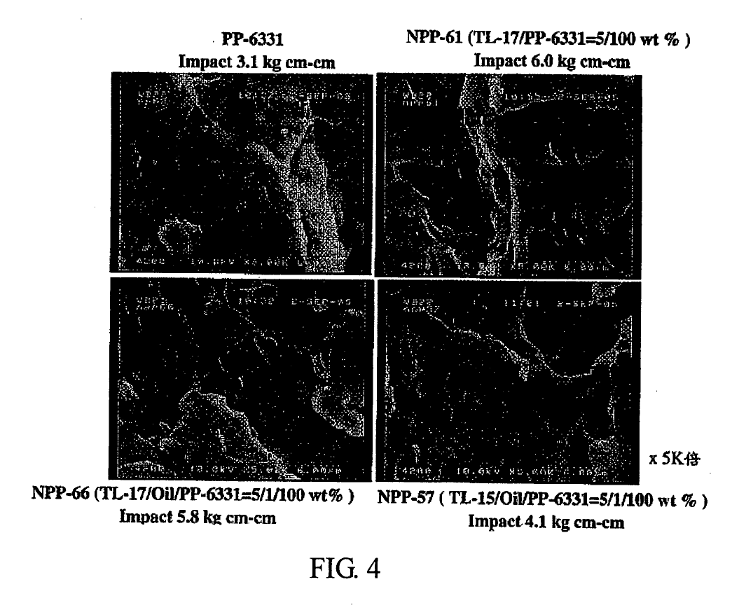

FIG. 3 and FIG. 4 are the comparison of surface electronic microscope (SEM) figures of nanocomposite material impact section, the side code formula of each figure is refer to table 2 and table 3. As shown in the figures, for PP-7633, it shows that the section of high tenacity (high notched izod impact) polypropylene-clay nanocomposite material comprises multiple twisted strips and the figure of pure polypropylene-clay nanocomposite material presents like tear-off particles, the notched izod impact is relatively decreased. On the other hand, as to PP-6331, the picture of impact section is a little different to PP-7633, the section of PP-6331 doesn't present in multiple twisted strips and the value of notched izod impact is smaller.

To sum up, the layers of organic modified bedded clay of present invention are provided with the silicone compound, which is able to increase tenacity, further it is able to add the coupling agent for improving the interface reactive ability, it make the clay and the polymer matrix form with a fine interface capacity. The nanocomposite material formed by mixing the clay and the polymer matrix is provided with the property of high rigidity and tenacity.

### Other Embodiments

The preferred embodiments of the present invention have been disclosed in the examples. All modifications and alterations without departing from the spirits of the invention and appended claims, including the other embodiments shall remain within the protected scope and claims of the invention.

The preferred embodiments of the present invention have been disclosed in the examples. However the examples should not be construed as a limitation on the actual applicable scope of the invention, and as such, all modifications and alterations without departing from the spirits of the invention and appended claims, including the other embodiments shall remain within the protected scope and claims of the invention.

What is claimed is:

1. An organic modified bedded clay comprising:
a bedded clay;
an alkyl amino salt compound with long carbon chain; and
a silicone compound with functional group, which is located between said bedded clay.

2. The organic modified bedded clay of claim 1, which comprises 10 wt %˜80 wt % said bedded clay; 10 wt %˜80 wt % said alkyl amino salt compound; and 10 wt %˜80 wt % said silicone compound.

3. The organic modified bedded clay of claim 1, wherein said bedded clay comprises an ion exchange equivalent ranging from 50˜200 meg/100 g.

4. The organic modified bedded clay of claim 3 wherein material of said bedded clay comprises MMT, mica, talcum powder or a mixture thereof.

5. The organic modified bedded clay of claim 1, wherein said alkyl amino salt compound with long carbon chain is provided with 8˜20 carbon.

6. The organic modified bedded clay of claim 5, wherein said alkyl amino salt compound with long carbon chain comprises Octadecyl amine or alkylbenzyl ammonium salt.

7. The organic modified bedded clay of claim 1, wherein said silicone compound is siloxanes.

8. The organic modified bedded clay of claim 1, wherein said siloxanes is silicone oil with amine group.

9. The organic modified bedded clay of claim 1, further comprises a coupling agent; said coupling agent is a silane compound with functional group.

10. The organic modified bedded clay of claim 9, wherein an adding volume of said coupling agent ranges from 0.1 wt % 20 wt %.

11. The organic modified bedded clay of claim 9, wherein said functional group of said silane compound comprises amino, acryl glycidyl, acrylic acid or methacrylic acid group.

12. The organic modified bedded clay of claim 9, wherein said silane compound comprise γ-amino propyl trimethoxy silane, γ-acryl glycidyl propyl trimethoxy silane or γ-methacrylic propyl trimethoxy silane.

13. A preparing method of organic modified bedded clay, comprising the following steps:
(a) providing a bedded clay;
(b) dispersing said bedded clay in a solution;
(c) adding an alkyl amino salt compound with long carbon chain into said solution of step (b) for reaction;
(d) adding a silicone compound with functional group for reaction and then to form a precipitate; and
(e) drying said precipitate of step (d).

14. The method of claim 13, wherein said solution of step (b) is aqueous solution.

15. The method of claim 13, wherein said reaction of step (c) and step (d) is ion exchange reaction.

16. The method of claim 13, further comprises a step for adjusting pH value of solution lower than 7 before said step (b).

17. The method of claim 13, wherein said silicone compound is siloxanes.

18. The method of claim 17, wherein said siloxanes is silicone oil with amine group.

19. The method of claim 13, further comprises a step of adding coupling agent; said coupling agent is a silane compound with functional group.

20. The method of claim 19, wherein said functional group of said silane compound comprises amino, acryl glycidyl, acrylic acid or methacrylic acid group.

21. The method of claim 20, wherein said silane compound comprise γ-amino propyl trimethoxy silane, γ-acryl glycidyl propyl trimethoxy silane or γ-methacrylic propyl trimethoxy silane.

22. A nanocomposite material, comprising:
a bedded clay;
an alkyl amino salt compound with long carbon chain;
a silicone compound with functional group, which is located between said bedded clay; and
at least one polymer matrix, which is mixed between said bedded clay.

23. The nanocomposite material of claim 22, which comprises 1 wt %˜12 wt % said bedded clay; 1 wt %˜10 wt % said alkyl amino salt compound with long carbon chain; 1 wt %˜12 wt % said silicone compound with functional group; and 80 wt %˜90 wt % said polymer matrix.

24. The nanocomposite material of claim 22, which is obtained by melting and mixing the organic modified bedded clay of claim 1 and said polymer matrix.

25. The nanocomposite material of claim 22, wherein said polymer compound comprises polyolefin compound, polyamide compound or polyester compound.
